(19) United States
(12) Patent Application Publication
(10) Pub. No.: US 2023/0249769 A1
(43) Pub. Date: Aug. 10, 2023

(54) MANAGING, RECHARGING AND PROTECTING SYSTEM

(71) Applicant: EVOLVO S.R.L., Torino (IT)

(72) Inventor: Igor TEMPO, Torino (IT)

(21) Appl. No.: 18/015,106

(22) PCT Filed: Feb. 24, 2021
(86) PCT No.: PCT/IT2021/050041

§ 371 Date: Jan. 9, 2023

(30) Foreign Application Priority Data
Jul. 10, 2020 (IT) 102020000016771

(51) Int. Cl. B62H 5/20; B60L 53/16; B60L 53/31

(52) U.S. Cl. CPC B62H 5/20; B60L 53/16; B60L 53/31; B60L 2240/622; B60L 2270/36; B60L 2200/12; B60L 53/66

(57) ABSTRACT

A managing, recharging and protecting system (1) is described including: a first central processing unit, CPU (3) containing at least one managing and control application; a second central processing unit (4) operatively connected to said first central processing unit (3); at least one anti-theft device (5) designed to be wrapped around an article (10) to be protected and operatively connected to said central processing unit (4); at least one charging column (9) operatively connected to said anti-theft device (5) and designed to recharge said article (10) when connected to it.

The present invention refers to an electronic managing, recharging and protecting system, in particular for bicycles and mopeds.

Various systems for the safety and control of electronic two-wheeled vehicles are known in the art.

Such systems do not allow users to have complete control over their vehicles via personal telephone applications.

Furthermore, these electric vehicles must be constantly recharged and kept safe by different devices making these operations impractical.

Object of the present invention is solving the aforementioned prior art problems by providing a managing, recharging and protecting system capable of detecting its position via GNSS and can communicate it to the cloud together with other information such as the status of the system and of the battery, any alarms or anomalies, using the GSM connection.

These data are stored on the cloud and made available to the user and to the service manager who connects via a dedicated app and providing the correct credentials.

Furthermore, if the user is in the vicinity of the vehicle, via a direct Bluetooth connection and therefore even in the absence of telephone coverage, he is able to give commands to the vehicle, such as authorization to charge, or unlocking the safety cable.

The aforesaid and other objects and advantages of the invention, which will emerge from the following description, are achieved with a managing, recharging and protecting system such as that described in claim 1. Preferred embodiments and non-trivial variants of the present invention form the subject of the dependent claims.

It is understood that all attached claims form an integral part of the present description.

It will be immediately obvious that innumerable variations and modifications (for example relating to shape, dimensions, arrangements and parts with equivalent functionality) can be made to what is described without departing from the scope of the invention as appears from the attached claims.

The present invention will be better described by some preferred embodiments, provided by way of non-limiting example, with reference to the attached drawings, in which:

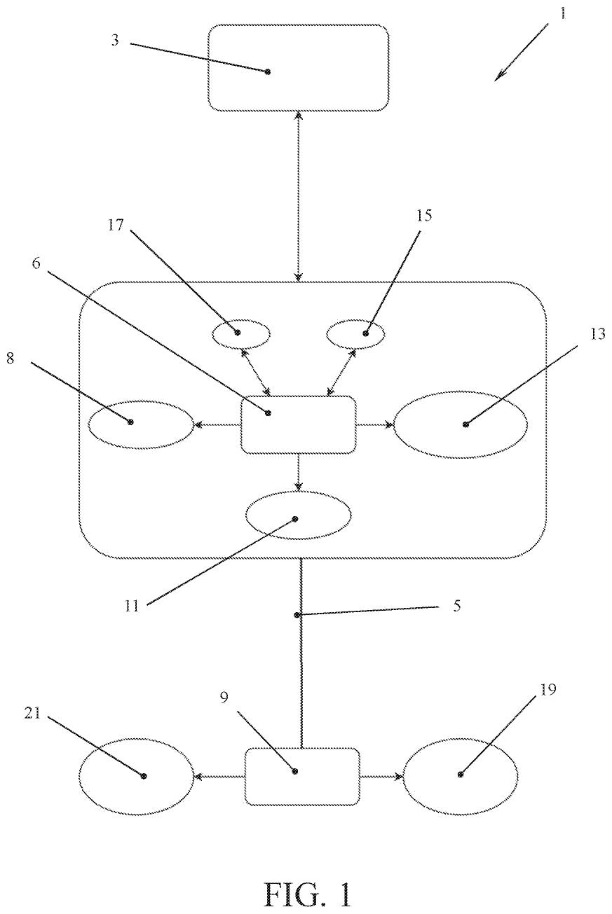

FIG. 1 shows a block diagram of an embodiment of the managing, charging and protecting system according to the present invention;

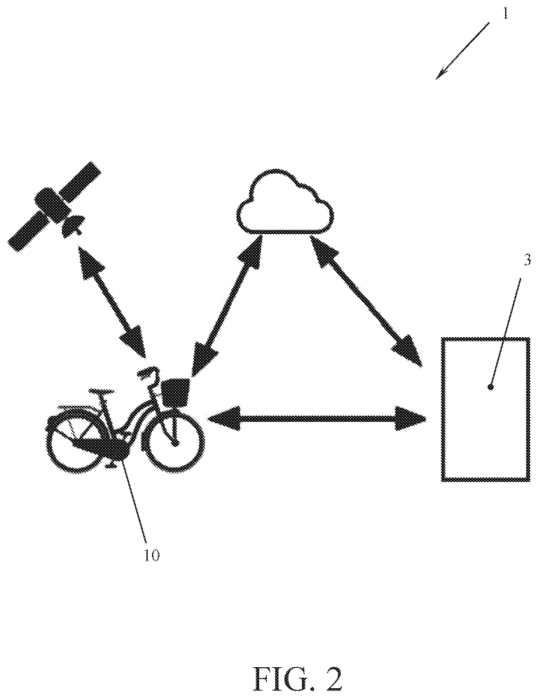

FIG. 2 shows another block diagram of an embodiment of the managing, recharging and protecting system according to the present invention.

Referring to FIG. 1 it is possible to note that the managing, recharging and protecting system 1 comprises:
a first central processing unit, CPU 3 containing at least one managing and control application;
a second central processing unit 4 operatively connected to the first central processing unit 3;
at least one anti-theft device 5 designed to be wrapped around an article 10, preferably an electric bicycle or a moped, to be protected and operationally connected to the central processing unit 4;
at least one charging column 9 operationally connected to the anti-theft device 5 and designed to recharge the article 10 when connected to it.

Advantageously, the second central processing unit 4 comprising at least one microcontroller 6 which controls:
at least one first lock release device 8 designed to release the protecting locks of the system 1;
at least one sound anti-theft device 11 designed to activate an audible alarm signal when the anti-theft device 5 is tampered with and/or cut;
at least one sensor control and managing device 13 designed to monitor the charge level of article 10 and/or system 1.

Furthermore, the microcontroller 6 is operationally connected to:
at least one location device 15 designed to cooperate operationally with system 1 by communicating the position of article 10;
at least one transmission device 17, for example of the Bluetooth or GSM type.

In particular, the charging column 9 is equipped with at least one power supply 19 and at least one second lock release device 21.

Advantageously, the anti-theft device 5 is designed to connect also operationally to the charging column 9 to recharge the article 10.

Furthermore, the anti-theft device 5 is designed to be brought into the open position, which allows the release of at least one article 10 from the charging column 9 to which it was connected for recharging, and a closed position, which prevents extraction of article 10 from the charging station 9.

The anti-theft device 5 is also operationally connected to at least one anti-theft activation system capable of activating a further sound-type warning signal when the anti-theft device 5 is connected to the recharging column 9 in the event of an anomaly or non-activated alarm.

In particular, the managing, charging and protecting system 1 comprises a plurality of actuators designed to carry out an unlocking sequence of the system 1.

Advantageously, the system 1 of the invention can also comprise at least one vibration sensor, preferably in the form of an ampoule, with a sensitive contact or an accelerometer, designed to detect vibrations in the system.

In addition, the managing and control application of the managing, charging and protecting system 1 is designed to perform the following functions:
unlock function: upon user command via Bluetooth (normal cases) or via GSM (exceptional cases) an unlock sequence will be performed using the actuators (solenoids or other);
charging function: if article 10 is connected to a charging column 9, the microcontroller 6, on command of the user, via Bluetooth (normal cases) or GSM (exceptional cases), can command the activation of the main battery charge or automatically by connecting the system to the column power supply;
anti-theft function: in the event that the anti-theft device 5 is cut or if the intervention threshold of the vibration sensor is exceeded and following an analysis on the profile of recognized vibrations, it must activate a signal via cloud to the user, and/or plant manager with activation of the local siren;
monitoring function: the microcontroller 6 monitors where possible the charge level of the battery of article 10 and system 1, in the event that article 10 is private, it only monitors the status of the system battery;
localization function: through the GNSS the microcontroller 6 will keep the position of article 10 upon request and will be able to communicate it to the cloud both for the user himself, and for roadside or medical assistance by the plant manager, or to trace missing or stolen vehicles; in the event that the alarm has been activated with the related alert, the system automatically sends the position to the cloud every 10 seconds; to disable the track every 10 seconds there will be a special button on the app (BIKE FOUND);
function reminds alarm activation anomaly: if the anti-theft device 5 is inserted into the charging column 9 or closed on itself and an anomaly occurs, from the next 5 seconds a buzzer sounds at intervals for 30 seconds after which an alert is sent on the app.

In particular, the managing, recharging and protecting procedure using system 1 comprising the phases of:
register the user by email, telephone number or other account + some personal data with communication from the App to the Cloud and from the Cloud to the bike, providing an always active two-way system (MQTT);
assign bikes from those available by providing a unique recognition system of the control unit/vehicle;
activate alarm and recharge via Bluetooth;
unlock and stop charging and deactivate the alarm system;
locate the bikes;
indicate the charging points on the map;
calculate the kilometers traveled;
generate maintenance expiration warning e-mail messages through the database to manage bikes and columns for maintenance cycles;
monitor stations and fleets in real time with the possibility of remote control;
notify on the user App in case of alarm;
CO2 saved;
money saved.

Furthermore, the process also including the steps of:
interface third party systems of public API;
convey public transport information;
make targeted advertising promotion by area/target user;
accumulate credits for the purpose of publication on social networks by the user;
remotely monitor charging;
manage payment and pricing systems.

The main hardware features of system 1 can be indicated in the following points:
power supply from the charging column 9 with a voltage of approximately 36-42V (or in any case consistent with the type of vehicle connected);
local 12V power supply with lithium battery which is recharged when the item 10 is connected to the power supply or column 9;
two main actuators consisting of two 12V solenoids with a consumption of approximately 1 Ampere to be kept active for a few seconds independently;
a speaker that can currently be used as a siren with the ability to generate different tones, but which can also receive an audio channel from the smartphone and play it, the necessary connection for the hardware must be present on the board;
a vibration sensor (in the form of an ampoule or other type) with a sensitive contact, or a MEMS accelerometer;
any other 12V I/O to control the activation of the charge, or recognize different connection conditions such as the guard cable;
any other analog I/O for measuring the voltages of the main vehicle battery (usually from 36V to 72V) and local 12V battery in order to determine the state of charge;
the card controller will be a Cortex M3, M4 or M4F microprocessor, the memory capacity can be at least around 64K of flash and 20K of RAM, up to more generous 256K of Flash and 64K of RAM. By staying within the same family of microprocessors, it will be possible to create prototypes with larger cuts, and then optimize production with smaller and less expensive cuts;
some signaling LEDs will be provided on the board and free I/O, especially for debug and diagnostic reasons. These parts may not be assembled in production for further cost savings, but they are very useful when debugging the program;
any microprocessor functions not used on the board will be in principle and where possible made available on an expansion connector for any future use or expansion;
Bluetooth BLE 4.0 or 5.0 peripheral to receive commands from a specific application on a smartphone and a possible audio stream;
GSM peripheral with 2G, 3G or 4G technology for bidirectional connection with the cloud with HTTP (S) protocol using a POST or a GET that the card will carry out to the cloud, passing any information, such as position, battery status or other, and will receive any commands queued for the card as a response from the cloud;
GNSS peripheral with access to various satellite networks for position detection. Eventually this module can be integrated with the GSM module if it is considered useful or advantageous during the development of the project;
JTAG or SWD connection will also be provided for programming on the production line and debugging the firmware. A virtual or physical serial will also be made available for diagnostics, setup and configuration, and as an interface for debugging during the product development phase and subsequent modifications.

10. (canceled).

11. A managing, recharging and protecting system comprising:
a first Central Processing Unit containing at least one managing and controlling application;
a second Central Processing Unit operatively connected to the first Central Processing Unit;
at least one anti-theft device designed to be wound around an item to be protected and operatively connected to the second Central Processing Unit; and
at least one recharging column operatively connected to the anti-theft device and designed to recharge the item when it is connected thereto.

12. The managing, recharging and protecting system of claim 11, wherein the second Central Processing Unit comprises:
at least one microcontroller;
at least one first unlocking device for locks designed to unlock the protecting locks of the system, the first unlocking device being controlled by the microcontroller;
at least one sound anti-theft device designed to activate an alarm signal of the sound type when the anti-theft device is tampered with and/or cut, the sound anti-theft device being driven by the microcontroller;
at least one sensor controlling and managing device designed to monitor the charge level of the item and/or the system, the sensor controlling and managing device being driven by the microcontroller;
at least one localizing device designed to operatively cooperate with the system communicating the position of the item, the localizing device being operatively connected to the microcontroller; and
at least one transmitting device, for example of the Bluetooth or GSM type, operatively connected to the microcontroller.

13. The managing, recharging and protecting system of claim 11, wherein the recharging column is equipped with at least one power supply and at least one second unlocking device for locks.

14. The managing, recharging and protecting system of claim 11, wherein the anti-theft device is designed to also be operatively connected to the recharging column to recharge the item, the anti-theft device being designed to be taken to its opening position which allows unlocking at least one item from the recharging column to which it had been connected for recharging, and its closing position which prevents the withdrawal of the item from the recharging column; and wherein the anti-theft device is operatively connected to at least one anti-theft activating system designed to activate a further warning signal of a sound type when the anti-theft device is connected to the recharging column.

15. The managing, recharging and protecting system of claim 11, further comprising a plurality of actuators designed to perform an unlocking sequence of the system.

16. The managing, recharging and protecting system of claim 11, further comprising a vibration sensor with sensitive contact or an accelerometer.

17. The managing, recharging and protecting system of claim 11, wherein the managing and controlling application is designed to perform the following functions:
unlocking function, upon a user command, through Bluetooth or through GSM, an unlocking sequence is performed through the actuators;
charging function, when the item is connected to the recharging column through the anti-theft device, upon a user command, through Bluetooth or GSM, the microcontroller drives an activation of the main battery charge of the item or automatically by connecting the system to the column power supply;
anti-theft function, in case the anti-theft device is cut or in case an intervention threshold is exceeded for the vibration sensor, and following an analysis on the recognized vibrations profile a signal is activated through cloud to the user, and/or to the plant manager by activating a local horn;
monitoring function of the microcontroller designed to monitor the charge level of the battery of the item and/or the system;
localizing function, through GNSS, the microcontroller designed to operatively cooperate with the system communicating the position of the item to the localizing device; and
anomalies signaling function, wherein an alert is sent to the managing and controlling application.

18. The managing, recharging and protecting system of claim 11, wherein the item is a bicycle or a scooter or a moped vehicle, in particular of an electric type or with assisted pedaling.

19. A process for managing, recharging and protecting, using the system of claim 11, the process comprising the steps of:
recording a user through mail/Facebook + some personal data with communication from App to Cloud and from Cloud to a bicycle, by providing an always active bi-directional system (MQTT);
assigning bicycles among those available by providing a univocal recognizing system of the unit/vehicle;
activating alarm and recharge through Bluetooth;
unlocking and ending the recharge and deactivating the alarm system;
locating the bicycles;
pointing out on a map the recharge points;
computing the travelled km;
generating warning messages about maintenance expiry through a database for managing bicycles and columns for maintenance cycles;
real time monitoring stations and fleets with change of a remote control;
warning on a user App in case of alarm; and
reminding the alarm activation when the anti-theft device is inserted in the column or closed on itself.

20. The process of claim 19, further comprising the steps of:
interfacing third party systems with public Api;
transmitting public transport information;
performing target advertising by user zone/target;
accumulating credits aimed to a publication on social networks by the user or to prize winning mechanisms;
remotely monitoring the recharge; and
managing payment and tariff systems.
